(19) United States
(12) Patent Application Publication
(10) Pub. No.: US 2010/0276512 A1
(43) Pub. Date: Nov. 4, 2010

(54) VARIABLE RANGE SPRINKLER APPARATUS AND VARIABLE RANGE SPRINKLER PATTERN METHOD

(75) Inventors: Juergen Nies, Winchester, VA (US); Ha Van Duong, Winchester, VA (US); Vicky Ann Michael, Winchester, VA (US)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MELNOR, INC., Winchester, VA (US)

(21) Appl. No.: 12/769,451

(22) Filed: Apr. 28, 2010

Related U.S. Application Data
(60) Provisional application No. 61/174,844, filed on May 1, 2009.

(51) Int. Cl. B05B 3/04

(52) U.S. Cl. 239/240

(57) ABSTRACT

A variable range sprinkler apparatus includes a sprinkler portion, a bypass unit housing a plurality of valves, and a water inlet portion. The sprinkler portion of the apparatus, which may be a rotary sprinkler unit, is attached to the bypass unit, and the bypass unit is coupled to the water inlet portion. Inside the bypass unit is a plurality of valves, at least one of which is adjustable, that are designed to open a water passage in the bypass unit.

### BACKGROUND OF THE INVENTION

The present disclosure relates to adjustable sprinklers used for irrigation and, more particularly, to a rotary sprinkler (above or below ground) which changes the rate of water flow to attain a predetermined irrigation pattern.

There are various types of sprinkler systems using different types of sprinklers (e.g., pulsating, rotary, oscillating, traveling, etc.) for irrigating lawns, farms, etc. Some systems include in-ground pop-up type sprinklers and others include portable type sprinklers that can be attached to a conventional garden hose.

Conventional rotary sprinklers (both pop-up and portable) typically spray water in a 360° pattern from the tip of a spray arm (or multiple spray arms) that spins as the sprinkler waters the lawn. These sprinklers may also be partially adjusted (electronically or mechanically) to rotate such that only a segment (e.g., 90 degree, 270 degree, etc.) of a circular path is watered. One example of such a sprinkler being mechanically adjustable is disclosed in U.S. Pat. No. 4,892,252. This design, however, can not be effectively deliver water in a complex watering pattern (e.g., desirable for non-circular areas to be watered).

Due to limited adjustability, such conventional rotary sprinklers waste water (e.g., resulting in higher water bills and potential local ordinance violations) due to over-spraying non-circular areas.

### SUMMARY OF THE INVENTION

One aspect of the invention includes a variable range sprinkler apparatus having a sprinkler portion, a bypass unit housing a plurality of valves (2-8, preferably 6), and a water inlet portion. The sprinkler portion of the apparatus, which may be a rotary sprinkler unit, is attached to the bypass unit, and the bypass unit is coupled to the water inlet portion. Inside the bypass unit is a plurality of valves, at least one of which is adjustable, that are designed to open a water passage in the bypass unit.

The apparatus may use a plurality of ball valve, each designed with a water passage for directing water through the bypass unit.

The apparatus may also include a rotatable water outlet unit or assembly arranged inside the bypass unit that accommodates a main axle extending downward from the rotary sprinkler portion of the apparatus to the water inlet portion of the apparatus.

The bypass unit may be a single unit or an assembly of an upper housing that is rotatably attached to the sprinkler portion, a lower housing that is coupled to the upper housing, and a base plate that is coupled to the lower housing and the water inlet portion of the apparatus.

The bypass unit may be designed to house a plurality of valve chambers that are arranged in a ring-like fashion, wherein each of the chambers accommodates a valve.

In order to enable a user to easily adjust the valve(s) located inside the apparatus, the apparatus may include a valve adjustment unit (or knob) coupled to a valve and located outside of the bypass unit.

According to one aspect of this invention, the apparatus is equipped with a main axle that is designed to direct water in and out of the bypass unit at desired locations.

According to one aspect of this invention, the rotatable water outlet unit includes a top outlet unit having a first portion extending from a second portion thereof, and a water outlet plate positioned inside the second portion of the top outlet unit. The first portion may have a smaller outside diameter than the second portion. The main axle may extend through a center portion of the water outlet unit, both top outlet unit and water outlet plate. An outside diameter of the water outlet plate may be substantially equal to an inside diameter of the second portion of the top outlet unit.

According to one aspect of this invention, the water outlet may include a plate portion, a protrusion extending upward from a top surface of the plate portion, and a cutout portion formed through the plate portion. A height of the protrusion may be substantially equal to a depth of the second portion of the top outlet unit. The cutout portion may be configured to align with a water passageway outlet of a valve as the water outlet unit rotates. The width of the cutout portion may be formed greater than or equal to a sum of A and B, wherein A is a diameter of the water passageway outlet, and B is a minimum distance between adjacent water passageway outlets.

To provide further rigidity, the water outlet plate may include a support ridge extending upward from a top surface thereof.

According to one aspect of this invention, the water outlet may include a plurality of protrusions spaced apart in a ring-like manner, wherein a passageway is defined by adjacent protrusions. The passageway may communicate water from the bypass unit to a water outlet aperture of the main axle.

According to one aspect of this invention, the apparatus includes a generally cylindrical sleeve located between an inside surface of the bypass unit and an outside surface of a large diameter portion of the water outlet unit. The sleeve may be attached to an inside surface of the bypass unit and may function as a water seal for the water outlet unit and it may also function to reduce friction that may be generated between the rotating water unit and the bypass unit.

Another aspect of this invention includes a unit for selectively bypassing water. The unit includes a housing, a plurality of valve chambers positioned inside the housing, and a plurality of valve assembly units. The plurality of valve chambers is arranged in a ring-like fashion and the valve assembly units are individually positioned inside the plurality of valve chambers. At least one of the valve assembly units is adjustable and at least one of the adjustable valve assembly units includes a valve coupled to an adjustment unit. Each of the adjustment unit adjusts the position of the valve it is coupled to.

Another aspect of this invention involves a method for adjusting water to flow through a sprinkler apparatus. The method involves adjusting a first valve of the apparatus to a first position and then adjusting a second valve of the apparatus to a second position. The valves are adjusted independently from one another. The first position influences a flow of the water exiting the sprinkler apparatus at a first time (T=1) and the second position influences the flow of the water exiting the sprinkler apparatus at a second time (T=1+n).

### BRIEF DESCRIPTION OF DRAWINGS

The present disclosure is illustrated by way of example and not limited in the figures of the accompanying drawings in which like references indicate similar elements.

FIG. 1 shows a front view of a rotary sprinkler according to one embodiment;

FIG. 2 shows a cross-section view of the sprinkler of FIG. 1;

FIG. 3 shows a sectional view of the sprinkler, including water flow diagram, of FIG. 1;

FIG. 4 shows a cross-section along the lines A-A of a portion of the sprinkler shown in FIG. 3;

FIG. 5 shows a cross-section along the lines B-B of the portion of the sprinkler shown in FIG. 4;

FIG. 6 shows an exploded assembly view of the sprinkler of FIG. 1;

FIG. 7 illustrates one example of a spray pattern of the sprinkler shown in FIG. 1;

FIGS. 8a-d illustrates a first, second, third, and fourth embodiment of a ball valve adjustment unit;

FIGS. 9a-d illustrates a bottom, side, perspective, and cross-section, respectively, of an upper bypass housing unit according to one embodiment;

FIGS. 10a-d illustrates a bottom, side, perspective, and cross-section, respectively, of a lower bypass housing unit according to one embodiment;

FIGS. 11a-c illustrates a top, perspective, and cross-section, respectively, of a bypass plate according to one embodiment;

FIGS. 12a-d illustrates a top, perspective, elevation, and cross-section, respectively, of a ball valve subassembly according to one embodiment;

FIGS. 13a-b illustrates a top and cross-section, respectively, of a water outlet plate according to one embodiment;

FIGS. 14a-b illustrate a top and cross-section, respectively, of a main axle according to one embodiment; and

FIGS. 15a-b illustrates a top and cross-section, respectively, of a circular ring (sleeve) according to one embodiment.

FIGS. 16a-b illustrates system views of an above-ground and below-ground embodiment of a variable range sprinkler apparatus, respectively

### DETAILED DESCRIPTION OF THE DRAWINGS

All identically numbered reference characters correspond to each other so that a duplicative description of each reference character in the following drawings may be omitted.

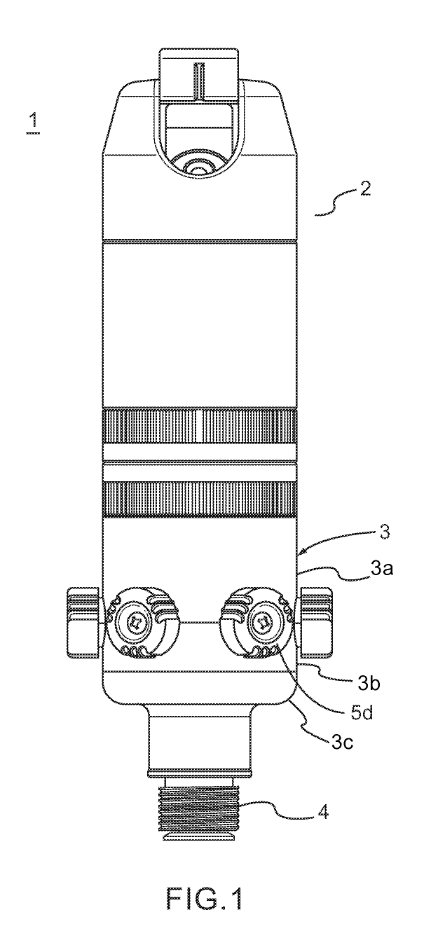

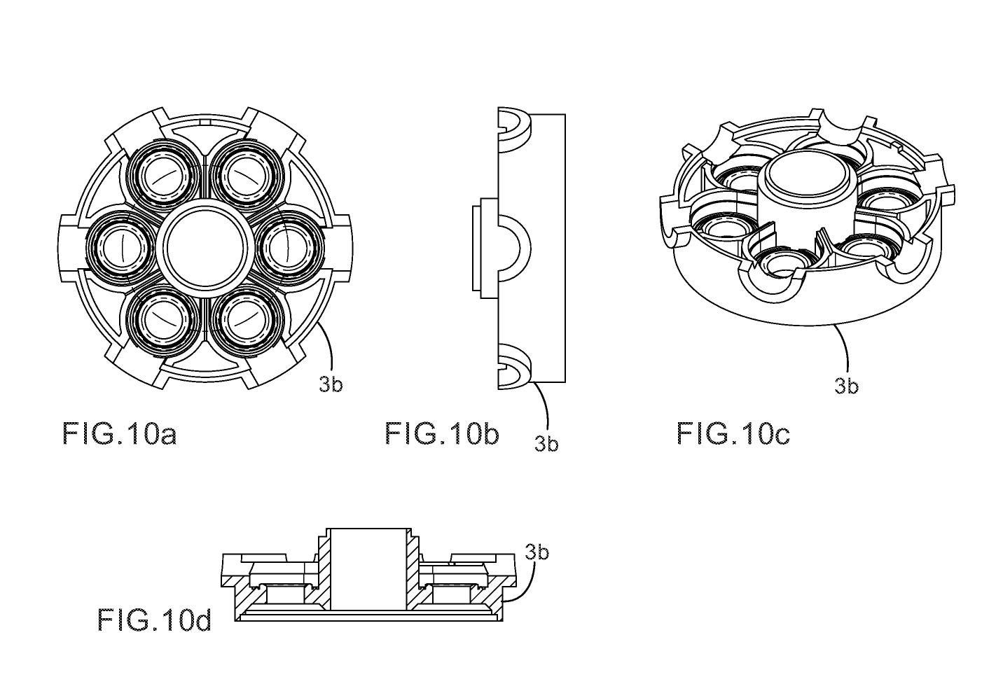

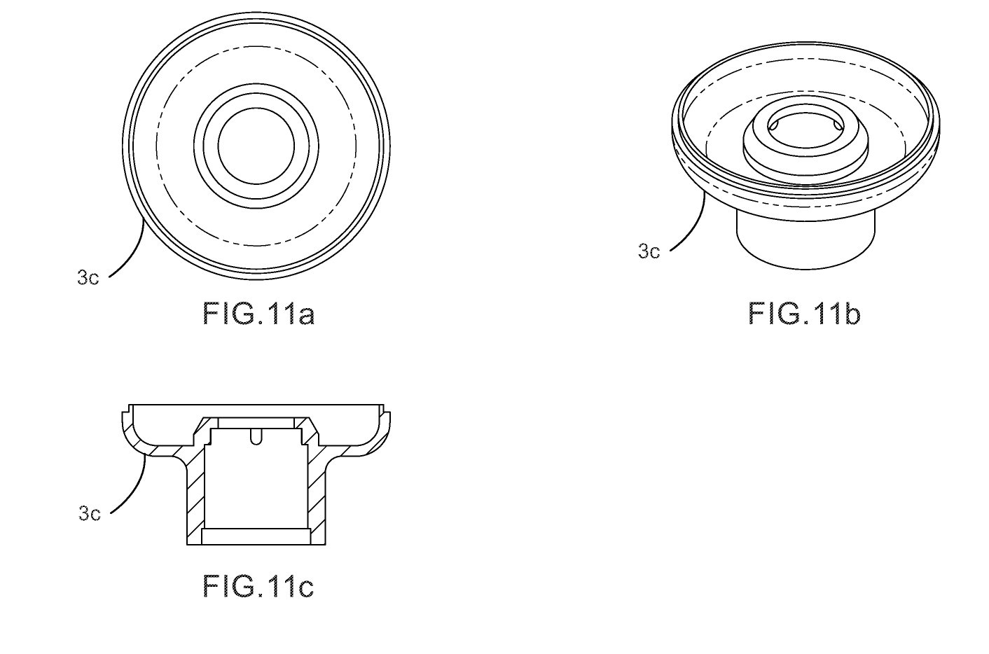

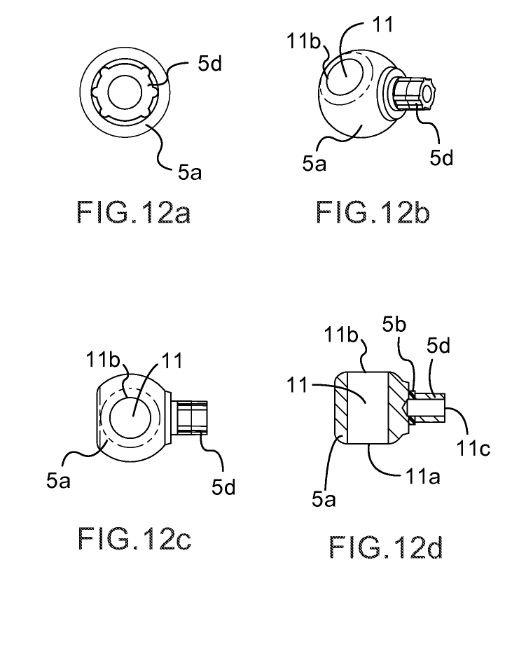

FIG. 1 shows a front view of one embodiment of a variable range rotary sprinkler apparatus 1 having a rotating sprinkler 2 (e.g., Melnor Model No. 2950 or any other suitable sprinkler) connected to a water bypass unit 3 that is connected to a water inlet 4. In this embodiment, the sprinkler is a rotary sprinkler (although apparatus 1 could incorporate a pulsating, pop-up, or other suitable type sprinkler) and water bypass unit 3 includes an upper bypass housing 3a, a lower bypass housing 3b, and a bypass plate 3c (top to bottom). FIGS. 9a-d illustrates a bottom, side, perspective, and cross-section, respectively, of one example of the upper bypass housing 3a. FIGS. 10a-d illustrates a bottom, side, perspective, and cross-section, respectively, of one example of the lower bypass housing 3b. FIGS. 11a-c illustrates a top, perspective, and cross-section, respectively, of one example of the bypass plate 3c. Not shown is a water supply source (e.g., hose) connected to water inlet 4 to communicate water through main axle 8 (described below) and bypass unit 3 to sprinkler 2. These components are preferably made of any suitable material, such as plastic, ABA or Delrin 500™.

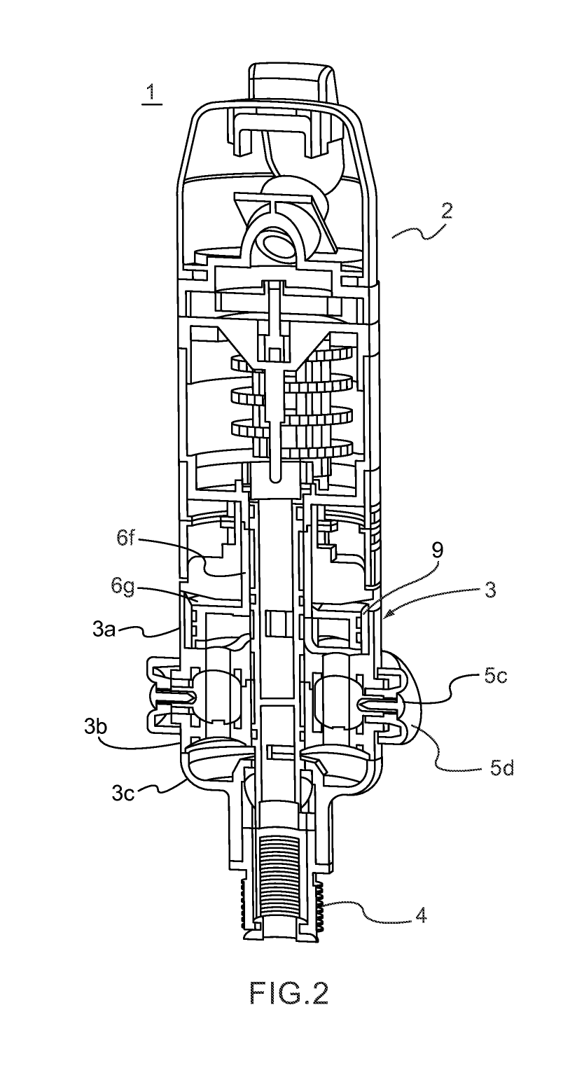

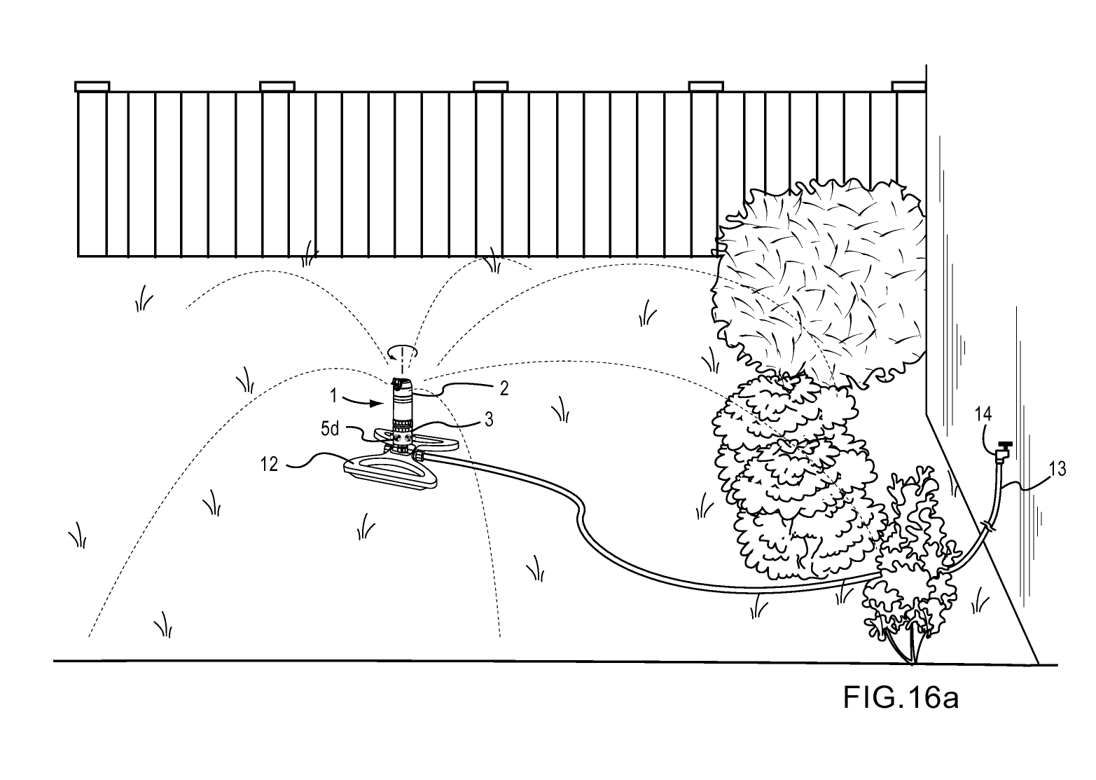

FIG. 2 (cross-section of FIG. 1) illustrates one embodiment of the present invention having a sleeve (e.g., cylindrical ring) 9 provided in a space between the upper bypass housing 3a and a large diameter portion of a generally cylindrical water outlet unit 6 (described below). As shown, the sleeve 9 is attached to an inside circumferential surface of the upper bypass housing 3a, for example, by a lock and key mechanism (other methods, such as snap, glue, and weld may also be used). The sleeve 9 is preferably made from a low friction or slippery-type material, such as Delrin 500™. The sleeve 9 is designed to improve sealing properties and reduce friction between the water outlet unit 6 and the upper bypass housing 3a. One or more o-rings (not shown) may also be sandwiched between the sleeve 9 and water outlet unit 6 to improve the water seal. FIGS. 15a-b illustrates a top and cross-section, respectively, of an example of a sleeve 9.

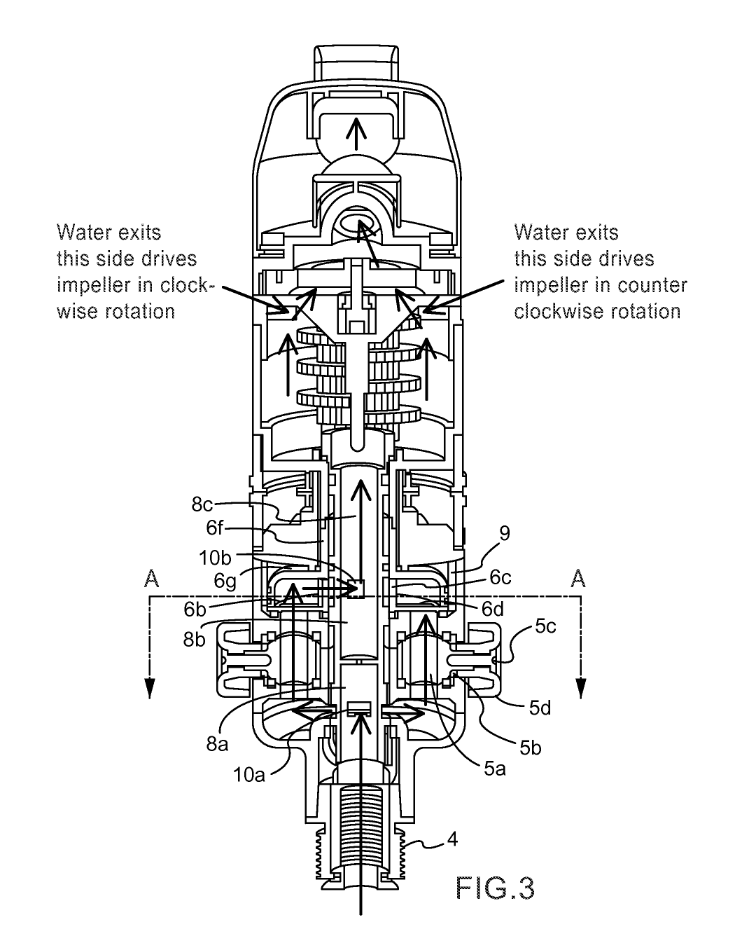

FIG. 3 illustrates one example of a water flow path inside apparatus 1. As shown, water enters water inlet 4 (at the bottom of apparatus 1), flows into a bottom end of a water inlet portion 8a of a main axle 8, flows out of the main axle 8 and into the bypass base plate 3c of the bypass unit 3 via a water inlet aperture 10a. The water is then directed upward inside the bypass unit 3 through a water passageway 11 in ball valve 5a (e.g., valve 5a may be a ball valve, plate valve, or any other suitable valve) and into the water outlet aperture 10b of the water outlet portion 8c of the main axle 8, and then flows into an internal gear assembly of sprinkler 2 via the water outlet portion 8c and exits the apparatus 1. In this embodiment, the water passageway 11 is a through-hole traversing the ball valve 5a along the main axis of the apparatus 1. Although a ball valve 5a is used in this embodiment, it is known that the bypass unit 3 may be designed with other suitable type valve, such as a plate valve.

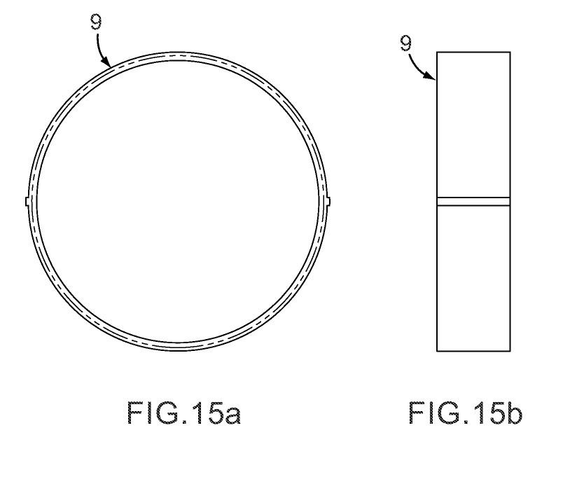

FIGS. 14a-b illustrates a top and cross-section view of an example of main axle 8.

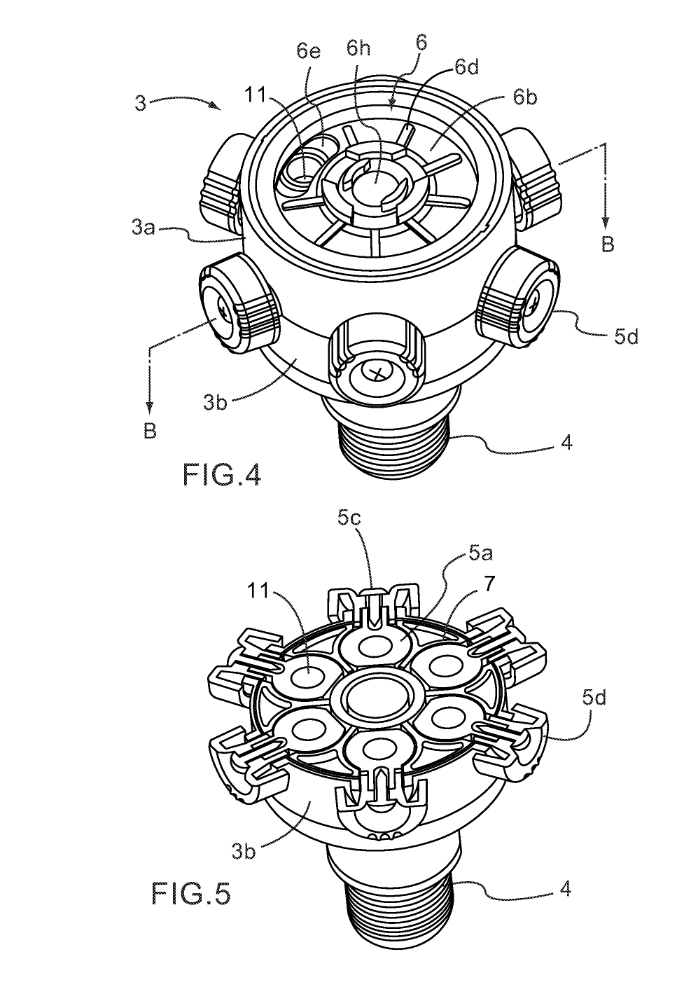

Cross-section A-A of apparatus 1 is illustrated in FIG. 4 and described below.

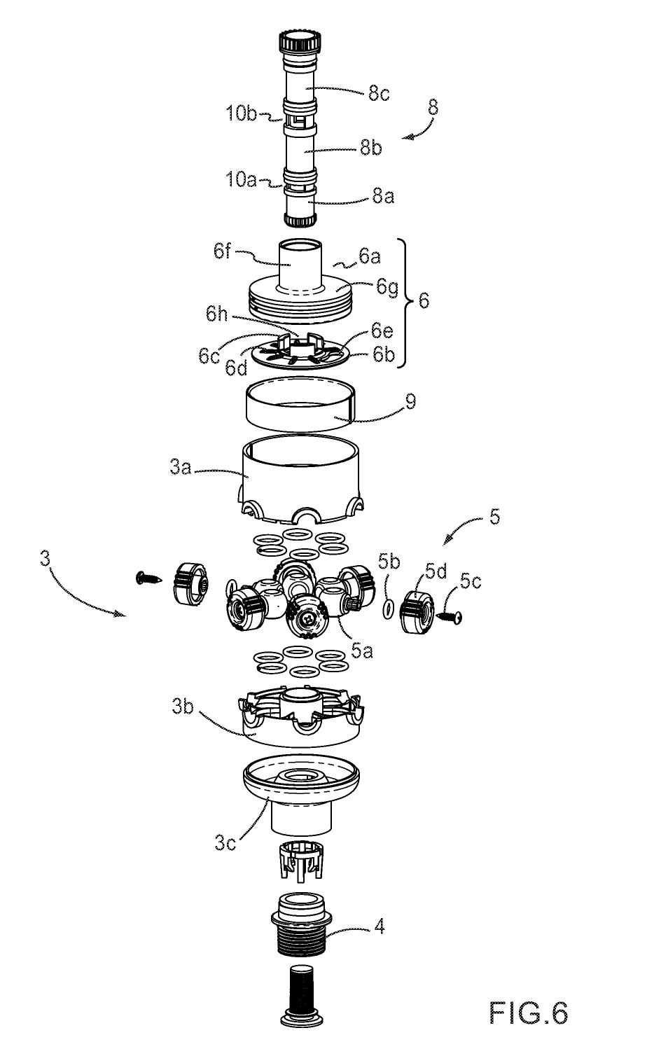

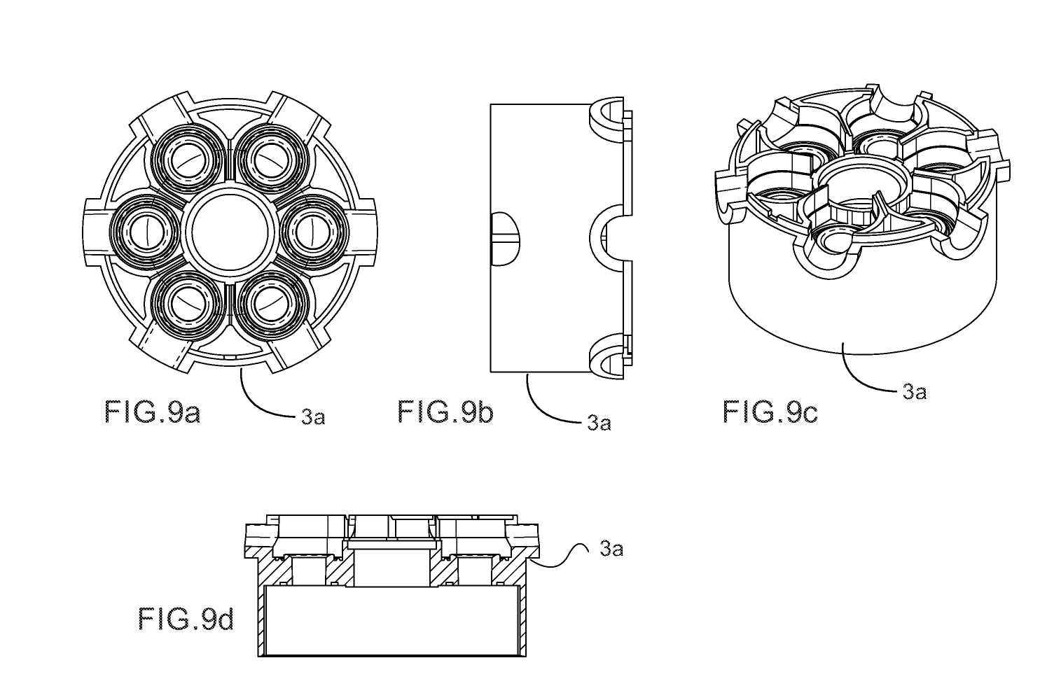

FIG. 5 illustrates a cross-section along the lines B-B of the portion of the sprinkler shown in FIG. 4. The lower bypass housing 3b includes a plurality of chambers 7 (e.g., ball valve chambers) that are spaced equally apart and arranged in a ring-like fashion inside the housing 3b. The chambers 7 may be integral with the housing 3b. Each chamber 7 accommodates a ball valve 5a that is coupled to a valve adjustment unit 5d (e.g., switch, wheel, button), located outside the bypass unit 3, via a valve fastener 5c (e.g., screws, rivets). FIGS. 8a-d illustrate different the apparatus equipped with four different adjustment units 5d.

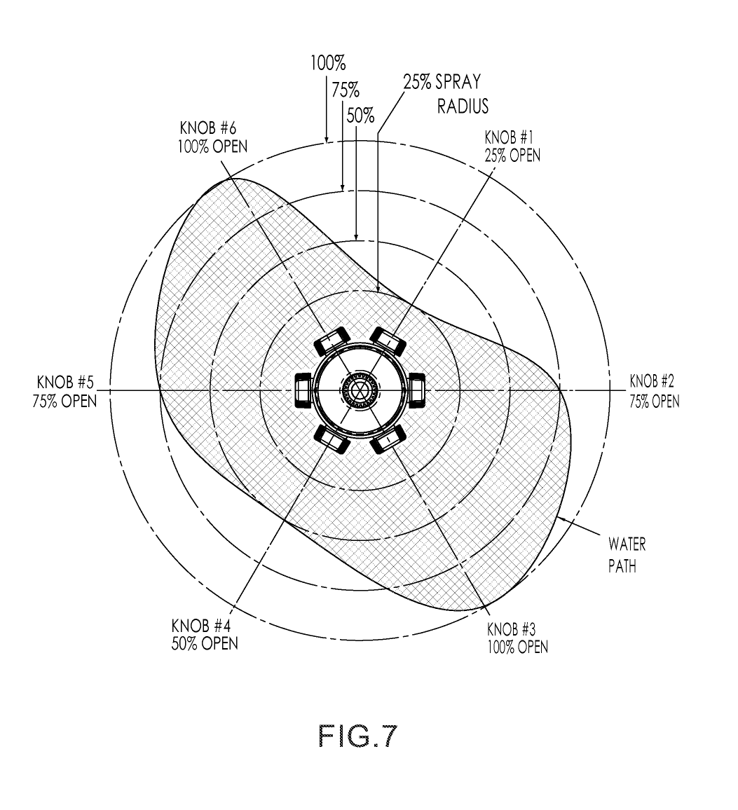

FIG. 6 illustrates an exploded assembly view of one embodiment of a variable range rotary sprinkler apparatus 1 having the water bypass unit 3, which may be made from any suitable material, such as plastic, ABA or Delrin 500™.

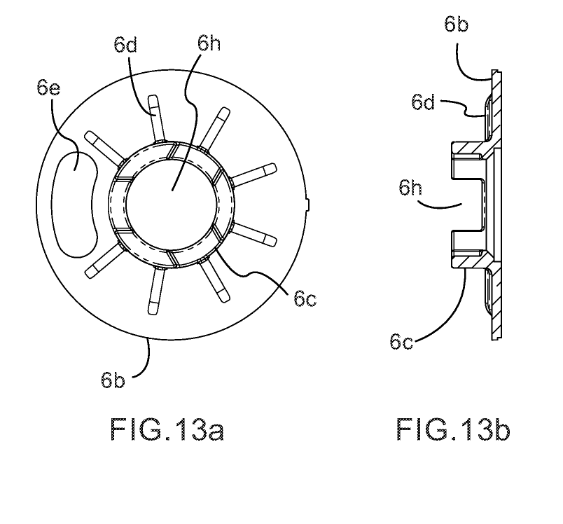

In this embodiment, the water bypass unit 3 comprises upper bypass housing 3a, lower bypass housing 3b, and bypass base plate 3c. The water bypass unit 3 houses a water outlet unit 6 and a valve subassembly 5. As shown, the valve subassembly 5 comprises a plurality of ball valves 5a, a plurality of valve o-rings 5b, a plurality of valve fasteners 5c, and a plurality of valve adjustment units 5d. Each valve 5a is arranged in a valve chamber 7. FIGS. 12a-d illustrates a top, perspective, elevation, and cross-section, respectively, of the ball valve subassembly 5. As shown in FIG. 6, subassembly 5 includes six ball valves 5a (e.g., each ball valve is designed to control 60° of a 360° degree pattern) and six chambers 7.

Main axle 8 is generally cylindrical and extends upward from a radial center portion of the bypass base plate 3c to a radial center portion of the sprinkler 2. The main axle 8 comprises water inlet portion 8a in communication with a water source (not shown), intermediate portion 8b, and water outlet portion 8c in communication with the sprinkler 2, arranged from bottom to top of apparatus 1. The water inlet portion 8a is hollow and comprises one or more water inlet apertures 10a formed on an outer circumference thereof, wherein the water inlet apertures are arranged inside bypass unit 3. The water inlet apertures 10 may be arranged at a portion of the main axle adjacent to the bypass base plate 3c (below the ball valve subassembly 5). The intermediate portion 8b is solid (no passageway) and is designed to redirect the incoming supply of water out of the water inlet aperture 10a and into the bypass unit 3. In this embodiment, the intermediate portion 8b is arranged entirely within the bypass unit 3. The water outlet portion 8c is hollow and comprises one or more water outlet apertures 10b formed on an outer circumference thereof, wherein the water outlet apertures 10b are arranged inside bypass unit 3. Main axle 8 is designed such that supply water enters the inside of the bypass unit 3 via the water inlet portion 8a and exits the bypass unit 3 and enters the rotating sprinkler 2 via the water outlet portion 8c.

The adjustable ball valves 5a, preferably six, are arranged in a ring-like fashion along an outer shell of bypass unit 3. FIG. 6 illustrates a subassembly 5 having six ball valves 5a, wherein each of the ball valves 5a are spaced apart and substantially equidistant from one another. Although six valves are shown, more or less may be incorporated into water bypass unit 3. Each of the ball valves 5a is individually connected to a ball valve adjustment unit 5d (examples of different units that may be used are shown in FIGS. 8a-d) via a fastener 5c (screw, bolt, rivet). FIG. 6 illustrates an apparatus 1 equipped with a knob (adjustment unit 5d) communicating with an outside surface of the ball valve 5a via a ball valve screw (fastener 5c).

Each adjustment unit 5d communicates with an opening 7 formed in an outside cylindrical surface of the bypass unit 3. According to one aspect of the present invention, a top half of each opening 7 is formed in a lower portion of the upper bypass housing 3a and a bottom half of each opening is formed in an upper portion of the lower bypass housing 3b to form a complete opening. Ball valve o-rings 5b may be provided at each of the openings formed in the ball valve 5a, water passageway inlet 11a, water passageway outlet 11b, and fastener opening 11c to reduce water leakage potential. Three openings (11a-c) per ball valve equates to three o-rings per ball valve. Each of the ball valves 5a can be individually adjusted by the adjustment unit 5d, which is designed to be adjusted from outside of the bypass unit 3 to open or close the water passageway 11 in the ball valve 5a a desired amount. The water passageway 11 may be designed to open in a range that permits a suitable amount of water to operate sprinkler 2 (e.g., opening range of 10-100%, more preferably 50-100%, wherein 100% is fully open).

The bypass unit 3 illustrated in FIG. 5 comprises six chambers 7, wherein each chamber 7 houses a ball valve 5a. The chambers 7 (e.g., wall portions) may be integrally formed into the bypass unit 3 (e.g., top portion of chamber arranged in the upper bypass housing 3a and the bottom portion of the chamber arranged in the lower bypass housing 3b). The chambers are designed to isolate water in each chamber in order to prevent water from flowing into the other chambers during operation.

The ball valve subassembly 5 is designed to reduce or increase the desired flow rate of input water at each particular ball valve location. An operator individually adjusts one or more of the ball valves via the adjustment unit 5d to adjust the amount of water desired at a particular location. As shown in FIG. 3, water bypass unit 3 is designed so that water from inlet 4 is channeled through a water passageway 11 of one of the ball valves 5a before ultimately entering the gear assembly.

In the embodiment shown in FIG. 3, the bypass unit 3 does not rotate, only water outlet unit 6 (e.g., comprising water outlet plate 6b and top outlet unit 6a) rotates in order to align a cutout 6e of the water outlet plate 6b to an opening in one or more of the ball valves 5a.

Water outlet unit 6 may be a one-piece unit having a top plate section formed therein or a two-piece subassembly as shown in FIGS. 3 and 6 and described below.

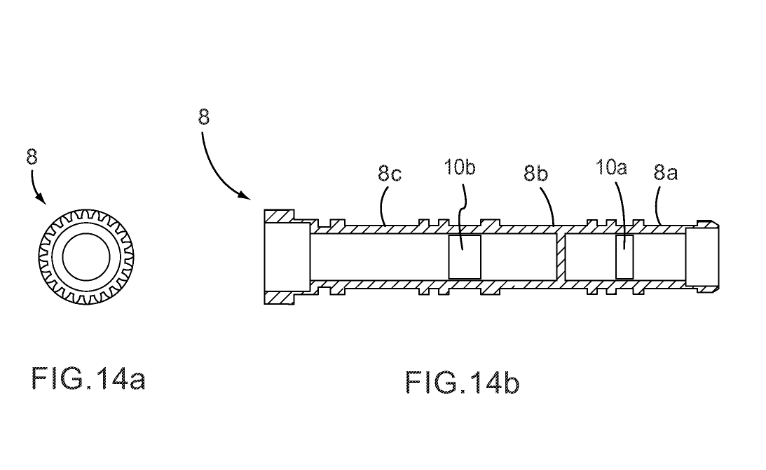

FIGS. 13a and 13b illustrate a top and cross-section, respectively, of one example of a one-piece water outlet plate 6.

FIG. 4 shows a cross-section along the lines A-A of a portion of the sprinkler shown in FIG. 3. The component parts are also shown in FIG. 6. According to the aspect shown in FIG. 4, the water outlet unit 6 comprises a water outlet plate 6b coupled to (e.g., snap fit, ultrasonically weld, glue, etc.) top outlet unit 6a. The water outlet unit 6a is adapted to receive main axle 8 through a center portion thereof. The top outlet unit 6a comprises a first portion 6f extending upward from a second portion 6g. According to the embodiment shown in FIG. 6, the diameter of the first portion 6f is less than the diameter of the second portion 6g.

The water outlet plate 6b may be formed, for example, from an ABS material or a friction reducing material (such as Delrin 500™). If the water outlet plate 6b is formed from Delrin 500™, then it is preferred that water outlet unit 6 be formed as a two piece subassembly in order to reduce material costs (e.g., Delrin 500™ can be used to form plate 6b and a less expensive material, such as ABS, can be used to form the top outlet unit 6a). Delrin 500™ is a low friction (slippery) material. Therefore, if the plate 6b is formed from this material, then the plate 6b can rotate without requiring much torque, even when applying pressure to the top of an o-ring (e.g., ball valve o-ring disposed on water passageway outlet 11b). However, if ball valve o-rings are not disposed on the water passageway outlets 11b, then the water outlet plate 6b may be formed from a standard ABS material (e.g., no friction problem).

As shown in FIGS. 13a-b, the water outlet plate 6b is circular and includes a plurality of protrusions 6c spaced apart in a ring-like manner and extending from a top surface thereof, a plurality of support ridges 6d extending from a top surface thereof, and a cutout portion 6e formed therein. The cutout portion 6e is located between the protrusions and the edge of the water outlet plate 6b. The protrusions are designed to provide rigidity to the outlet plate 6b and prevent the plate 6b from buckling due to opposing water forces. The space defined by adjacent protrusions forms a passageway 6h so that water can flow from the bypass unit 3 into the water outlet aperture 10b of the main axle 8.

According to one aspect of the disclosure, the height of the protrusion 6c is substantially equal to the depth of the second portion 6g (large diameter portion) of the top outlet unit 6a.

According to one aspect of the disclosure, the width of the cutout portion 6e should be equal to or greater than the diameter of one ball valve opening 11b and the distance between adjacent ball valve openings (e.g., valve 1 and the gap between valve 1 and valve 2). The shape and size of the cutout portion is designed so that, as the water outlet unit 6 rotates, the cutout portion 6e aligns with at least one of the ball valve 5a water passageway openings 11. The cutout's width is designed so that it would start to open the next hole as soon as it begins closing the current one.

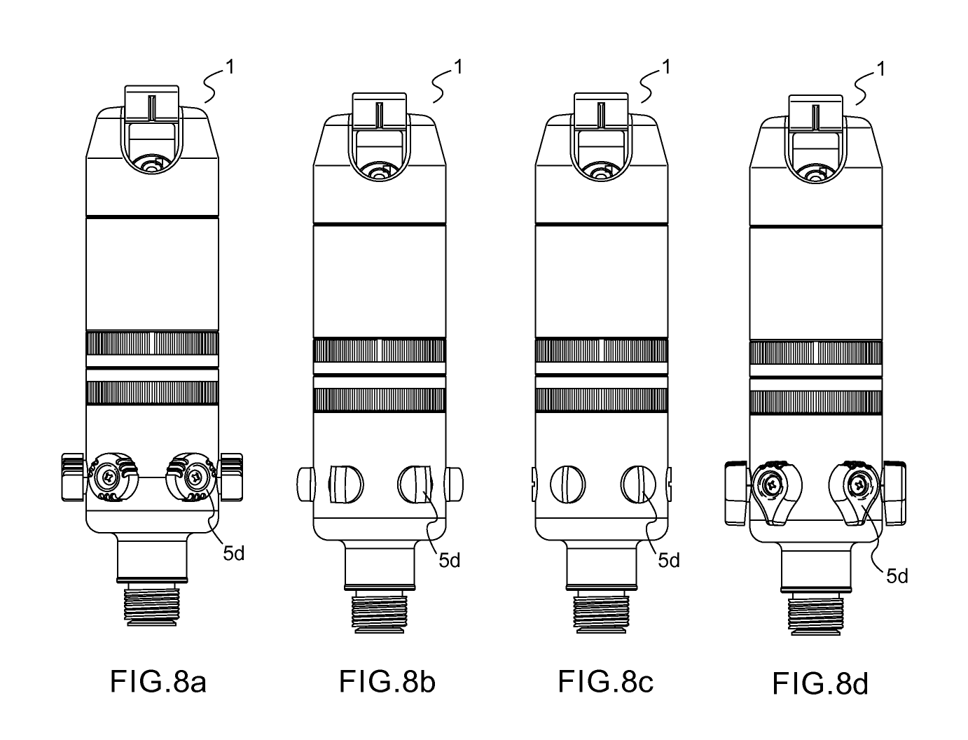

FIG. 7 illustrates one example of a variable range rotary sprinkler spray pattern simulation area. Apparatus 1 is designed to allow a user to customize the water path exiting the sprinkler 2. In this example, bypass unit 3 includes six adjustable ball valves assemblies 5 (i.e., knobs 1-6) and a user adjusts each of the six knobs 5d so the corresponding ball valves are opened 25%, 75%, 100%, 50%, 75%, and 100%, respectively. The user then turns on the water flow to the apparatus 1 so that water flows into the apparatus 1 in the manner described above and illustrated in FIG. 2. As a result, the outcome is the customized spray pattern shown in FIG. 7. In this embodiment, depending on the valve position, the water can spray, for example, from 20-40 feet. One advantage of customizing spray pattern is the ability to conserve water.

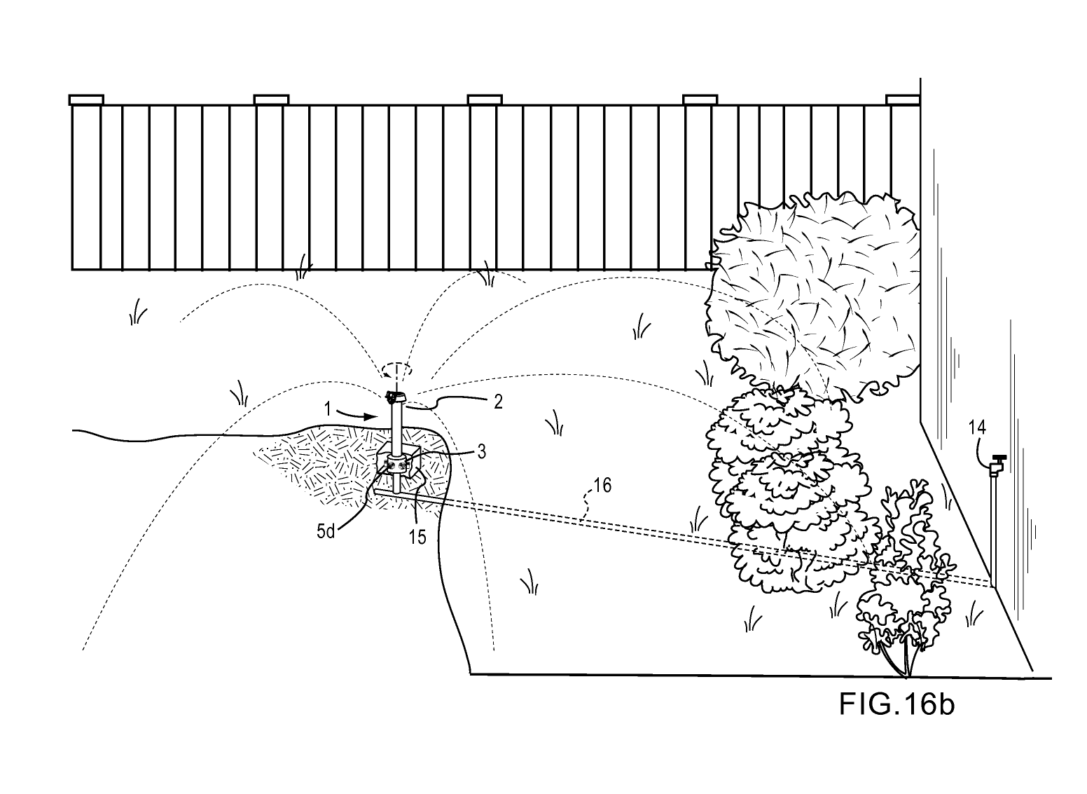

FIGS. 16a and 16b illustrate system views of an above-ground and below-ground embodiment of the variable range sprinkler apparatus 1, respectively.

In FIG. 16a, apparatus 1 includes a bypass unit 3, rotary sprinkler 2, and base 12. The base may be a flat base (such as included on Melnor Model No. 2960), a spike base (having one or more spikes penetrating into the ground), a telescoping base unit (as shown, for example, in U.S. application Ser. No. 12/181,867), or any other type of known base. A typical hose 13 connects the output of water source 14 (faucet) to an input of apparatus 1. Although not shown, the hose 13 may be attached to the water source 14 via a water timer device (not shown) that is operable with or without a water conservation device (such as the type shown in U.S. application Ser. No. 12/046,923 or U.S. application Ser. No. 12/046,944). In this embodiment, the base 12 is a flat base unit positioned on a surface of the lawn and the bypass unit 3 is positioned between the base unit 12 and the rotary sprinkler 2 of the apparatus 1. The user turns one or more of the knobs 5d of the bypass unit 3 a desired amount. The user then turns on the faucet 14 so that water flows through the hose 13 and into the apparatus 1 in the manner described above and illustrated in FIG. 2. As a result, the outcome is a spray pattern (e.g., such as shown in FIG. 7) designed by the user.

In FIG. 16b, apparatus 1 includes a bypass unit 3 attached to an underground pop-up rotary sprinkler 2, and housing 14 (which may or may not be included) designed to protect an underground portion of the apparatus 1. An underground pipe 16 connects the output of the water source 14 to an input of apparatus 1. Although not shown, a water timer device (not shown) may be connected to the pipe 16. Also, a water conservation device (not shown) may be added to the system. In this embodiment, the bypass unit 3 may be preset by the user (e.g., as described above in FIG. 7) before the apparatus 1 is inserted into a desired location in the ground. The housing 15 protects the bypass unit from the environment. In operation, the user turns on the faucet 14 so that water flows through the pipe 16 and into the apparatus 1 in the manner described above and illustrated in FIG. 2. As a result, the outcome is a spray pattern (e.g., such as shown in FIG. 7) designed by the user.

Although specific embodiments of the invention have been disclosed, it will be understood by those having skill in the art that changes can be made to those specific embodiments without departing from the spirit and the scope of the invention.

We claim:

1. A sprinkler apparatus comprising:
a sprinkler portion;
a bypass unit housing a plurality of valves; and
a water inlet portion, wherein
said sprinkler portion is rotatably attached to said bypass unit,
said bypass unit is coupled to said water inlet portion,
said plurality of valves is designed to open a water passage in said bypass unit, and
at least one of said plurality of valves is independently adjustable.

2. The sprinkler apparatus according to claim 1, wherein
said valve is a ball valve, and
said water passage is a through-hole in said ball valve that is disposed in an axial direction of said apparatus.

3. The sprinkler apparatus according to claim 1, further comprising:
a water outlet unit having an aperture formed in an approximate center portion thereof, and
a main axle extending downward from said sprinkler portion toward said water inlet portion of said apparatus, wherein
said aperture of said water outlet unit is adapted to receive said main axle, and
said water outlet unit is rotatable.

4. The sprinkler apparatus according to claim 1, said bypass unit comprising:
an upper bypass housing rotatably attached to said sprinkler portion;
a lower bypass housing coupled to said upper bypass housing; and
a bypass base plate coupled to said lower bypass housing and said water inlet portion.

5. The sprinkler apparatus according to claim 1, further comprising:
a plurality of valve chambers arranged in a ring-like fashion inside said bypass unit, wherein each of said chambers accommodates one of said plurality of valves.

6. The sprinkler apparatus according to claim 1, further comprising:
a fastener;
a valve adjustment unit coupled to at least one of said plurality of valves via said fastener; and
an aperture formed in an outside circumferential surface said bypass unit, wherein
said valve adjustment unit is located outside of said bypass unit, and
said aperture is designed to receive said fastener.

7. The sprinkler apparatus according to claim 2, wherein at least one of said ball valves is connected to a ball valve adjustment unit located outside of said bypass unit.

8. The sprinkler apparatus according to claim 3, said main axle comprising:
a hollow water inlet portion having a water inlet aperture communicating said hollow portion to an inside portion of said bypass unit,
a solid intermediate portion located above said inlet portion of said main axle, and
a hollow water outlet portion having a water outlet aperture communicating said hollow water outlet portion to said inside portion of said bypass unit, wherein
said intermediate portion is designed to redirect an incoming supply of water out of said water inlet aperture and into said bypass unit,
said water inlet aperture is located below said plurality of valves, and
said water outlet aperture is located above said plurality of valves.

9. The sprinkler apparatus according to claim 3, said rotatable water outlet unit comprising:
a top outlet unit having a first portion extending from a second portion thereof; and
a water outlet plate positioned inside said second portion of said top outlet unit, wherein
said first portion has a smaller outside diameter than said second portion,
said aperture extends through first portion, second portion, and said water outlet plate, and
an outside diameter of said water outlet plate is substantially equal to an inside diameter of said second portion of said top outlet unit.

10. The sprinkler apparatus according to claim 9, said water outlet plate comprising:
a plate portion;
a protrusion extending upward from a top surface of said plate portion; and
a cutout portion formed through said plate portion, wherein
a height of said protrusion is substantially equal to a depth of said second portion of said top outlet unit, and
said cutout portion aligns with at least one water passageway outlet of said valve as said water outlet unit rotates.

11. The sprinkler apparatus according to claim 9, wherein a width of said cutout portion is greater than or equal to a sum of A and B, wherein
A is a diameter of said water passageway outlet, and
B is a minimum distance between adjacent said water passageway outlets.

12. The sprinkler apparatus according to claim 10, said outlet plate further comprising:
a support ridge extending upward from said top surface of said plate portion.

13. The sprinkler apparatus according to claim 10, comprising:
a plurality of said protrusions spaced apart in a ring-like manner, wherein
a passageway is defined by adjacent said protrusions, and
said passageway is designed to communicate water from said bypass unit to said water outlet aperture of said main axle.

14. The sprinkler apparatus according to claim 3, further comprising:
a generally cylindrical sleeve located between an inside surface of said bypass unit and an outside surface of a large diameter portion of said water outlet unit, wherein
said sleeve is a water seal for said water outlet unit and reduces friction generated between said rotating water unit and said bypass unit.

15. The sprinkler apparatus according to claim 14, wherein said sleeve is attached to an inside circumferential surface of said bypass unit.

16. The sprinkler apparatus according to claim 1, wherein said sprinkler portion is a rotary sprinkler unit.

17. The sprinkler apparatus according to claim 1, wherein said bypass unit comprises six valve chambers and each of said valve chambers accommodates one of said plurality of valves.

18. A unit for selectively bypassing water, comprising:
a housing
a plurality of valve chambers positioned inside said housing; and
a plurality of valve assembly units, wherein
said plurality of valve chambers is arranged in a ring-like fashion,
said valve assembly units are individually positioned inside said plurality of valve chambers,
at least one of said valve assembly units is adjustable,
at least one of said adjustable valve assembly units comprises a valve coupled to an adjustment unit, and
said adjustment unit adjusts the position of said valve it is coupled to.

19. The unit for selectively bypassing water according to claim 18, wherein said valve is a ball valve and said adjustment unit is located outside of said housing and coupled to said ball valve via a fastener.

20. A method for adjusting water to flow through a sprinkler apparatus, comprising:
adjusting a first valve of said sprinkler apparatus to a first position;
adjusting a second valve of said sprinkler apparatus to a second position, wherein
said first position influences a flow of said water exiting said sprinkler apparatus at a first time (T=1),
said second position influences said flow of said water exiting said sprinkler apparatus at a second time (T=1+n), and
wherein said first valve is adjusted independently from said second valve.
